(19) United States
(12) Patent Application Publication
(10) Pub. No.: US 2020/0148278 A1
(43) Pub. Date: May 14, 2020

(54) Vehicle External Surface Component and Method for Producing a Vehicle External Surface Component

(71) Applicant: Webasto SE, Stockdorf (DE)

(72) Inventors: Matthias BAUMANN, Stockdorf (DE); Frank KIESEWETTER, Stockdorf (DE); Dirk LEGLER, Stockdorf (DE); Jan WOKOECK, Stockdorf (DE); Magnus SVIBERG, Stockdorf (DE)

(21) Appl. No.: 16/609,036

(22) PCT Filed: Apr. 24, 2018
(86) PCT No.: PCT/EP2018/060421

§ 371 Date: Oct. 28, 2019

(30) Foreign Application Priority Data
May 5, 2017 (DE) 10 2017 004 313.2

(51) Int. Cl. B62D 29/04; B32B 3/12; B32B 5/18; B32B 7/12; B32B 5/02; B29C 70/46; B29C 70/54; B29C 37/00

(52) U.S. Cl. CPC B62D 29/043; B32B 3/12; B32B 5/18; B32B 7/12; B32B 5/02; B29K 2075/00; B29C 70/545; B29C 37/0032; B32B 2264/101; B32B 2605/08; B29C 70/465

(57) ABSTRACT

A vehicle external surface component is disclosed having a layer structure having an SMC layer forming an outer skin layer and having a reinforcing structure connected to the SMC layer and having a core layer, wherein, according to some embodiments, the SMC layer has a reduced thickness of, for example, less than 2 mm, in particular 1.5 mm to 2.0 mm and particularly preferably 1.5 mm to 1.8 mm and/or has a reduced density of less than 1.3 kg/dm³, in particular between 1.2 kg/dm³ and 1.0 kg/dm³. The disclosure further relates to a method for producing such a vehicle external surface component.

The invention relates to a vehicle external surface component having a layered structure with an SMC layer forming an outer skin layer and having a reinforcing structure connected to the SMC layer and comprising a core layer, and to a method for producing a vehicle external surface component.

Such a vehicle external surface component is for example a cover of a roof opening system, such as a sliding roof or a spoiler roof, a surface component of a roof module or a trim component of a vehicle.

EP 1 524 175 A2 discloses a vehicle external surface component comprising an outer shell of a plastic with high surface quality, e.g. of an SMC material, and a reinforcing structure lying against the inner surface of the outer shell. The reinforcing structure consists of two layers of plastic spaced apart from one another, between which a honeycomb structure or a foam-like material is provided.

The invention is based on the object of providing a vehicle external surface component mentioned at the beginning that is improved with respect to reduced weight and has high strength, and providing a method for producing such a vehicle external surface component.

This object is achieved according to the invention in the case of the vehicle external surface component mentioned at the beginning by the SMC layer having a reduced thickness of less than 2 mm, in particular 1.5 mm to 2.0 mm and particularly preferably of 1.5 mm to 1.8 mm, and/or having a reduced density of less than 1.3 kg/dm³, in particular between 1.2 kg/dm³ and 1.0 kg/dm³.

The object is also achieved by a method having the features of claim 8 as well as by a method having the features of claim 11.

Advantageous refinements of the invention are respectively specified in the dependent claims.

By virtue of the fact that, according to a first solution, the SMC (sheet molding compound) layer has a reduced thickness of less than 2 mm, in particular 1.5 mm to 2.0 mm and particularly preferably of 1.5 mm to 1.8 mm, in combination with a lightweight and strong reinforcing structure it is possible to provide a vehicle external surface component which, on account of the reduced thickness of the SMC layer, is significantly more lightweight in comparison with known vehicle external surface components.

On the other hand, according to a second solution, whereby the SMC layer has a reduced density of less than 1.3 kg/dm³ and in particular between 1.2 kg/dm³ and 1.0 kg/dm³, a weight advantage can be achieved for the vehicle external surface component by reducing the specific weight of the SMC material. Nevertheless, the lightweight reinforcing structure allows the strength of the vehicle external surface component to be maintained or even increased in comparison with known vehicle external surface components. The reduction of the density can be attained by the addition of fillers such as hollow glass beads or the like, the weight of which is significantly lower than the weight of the resin of the SMC material.

A combination of the first solution with the second solution combines the advantages that can be achieved in each case.

In the case of these solutions, it is expedient if the SMC layer has a weight per unit area of less than 4 kg/m² and in particular between 2.5 kg/m² and 1.2 kg/m². A strength-optimized and weight-optimized vehicle external surface component is thereby provided.

In a preferred configuration, a paintable in-mold coat layer is applied to the SMC layer. The thin, reduced-density SMC layer is not paintable or is not paintable in a sufficient quality. The paintable in-mold coat layer, which together with the SMC layer forms the outer skin layer, allows a paint finish with class A surface quality.

The reinforcing structure expediently comprises an inner cover layer of plastic that predominantly contains polyurethane or is produced from polyurethane and is applied to the core layer on its inner side that is opposite the outer skin layer. The polyurethane is used as an adhesive to fasten the cover layer of plastic to the core layer, ensuring an intimate bond to the core layer and being able to penetrate into it in the case of a material suitable therefor. The component inner side may be lined directly with a fabric.

In a preferred configuration, the outer skin layer is applied to the outer side of the core layer facing the outer skin layer by means of an outer cover layer of plastic that predominantly contains polyurethane or is produced from polyurethane. The outer cover layer of plastic may comprise a reinforcement, e.g. by a fiber reinforcement or a fiber mat, whereby the strength is increased. For the application of the outer skin, both an outer cover layer of plastic reinforced in such a way and an outer cover layer of plastic without this reinforcement may be used.

It is particularly preferred that the inner cover layer of plastic and/or the outer cover layer of plastic comprise/comprises a fiber reinforcement, e.g. with glass fibers, or a fiber mat. The optional use of a fiber or fiber mat reinforcement allows a specific configuration of the different layers with respect to an optimized high strength, in particular flexural strength or strength e.g. against hailstones. The plastic or the polyurethane substantially forms the adhesive, while the fiber reinforcement provides the required strength.

A particularly preferred embodiment provides that the core layer of the reinforcing structure is produced from a honeycomb or a foam. In this case, the honeycomb may preferably be produced from paper, from aluminum or from a plastic such as e.g. phenolic resin. A honeycomb is also understood to mean e.g. components or spacer parts extending in a wave shape and perpendicularly to the at least one cover layer of plastic.

A particularly lightweight and nonetheless strong vehicle external surface component, as has in particular been described above, can be produced by a method according to the invention as claimed in claim 9. The method for producing a vehicle external surface component, in particular formed in accordance with the preceding embodiments, comprises the steps of:

a) producing an SMC layer including a thin IMC layer as a semifinished product forming an outer skin layer in a standard production method for SMC components,
b) inserting the coated SMC layer into a mold half of a composite mold,
c) pressing a reinforcing structure bearing the outer skin layer and comprising a core layer covered with at least one cover layer of plastic into the SMC layer with an as yet uncrosslinked adhesive or polyurethane so as to shape the vehicle external surface component, and
d) demolding the vehicle external surface component.

Expediently, after the demolding of the vehicle external surface component (step d), at least one further method step, such as trimming or cutting to size the edges of the vehicle external surface component, may be carried out.

Furthermore, in the case of this method, in step a) either the thin IMC layer may be provided with an outer-surface paint finish or, as an alternative thereto, the SMC layer is provided with a paintable thin IMC layer and in a step e) the vehicle external surface component is painted, e.g. in the color of the car or in a contrasting color.

In addition, a particularly lightweight and nevertheless strong vehicle external surface component can likewise be produced by a method according to the invention as claimed in claim 12. Here, the following steps are performed:

a) producing an SMC layer as a semifinished product in a standard production method for SMC components,
b) inserting the SMC layer into a first mold half of a molding tool and pressing the SMC layer by means of a second mold half,
c) applying an IMO paint layer to the SMC layer facing the first mold half so as to form an outer skin layer,
d) exchanging the second mold half for a mold half with an enlarged mold cavity,
e) inserting a reinforcing structure bearing the outer skin layer and comprising a core layer covered by at least one cover layer of plastic into the enlarged mold cavity, and
f) pressing the reinforcing structure into the SMC layer with an as yet uncrosslinked adhesive or polyurethane so as to shape the vehicle external surface component.

As in the case of the first-mentioned method, after the demolding, another method step may be performed and also a paint finish applied.

The invention is explained in more detail below on the basis of exemplary embodiments of a vehicle external surface component according to the invention with reference to the drawing, in which;

FIG. 1 shows a vehicle external surface component according to the invention in a sectional view;

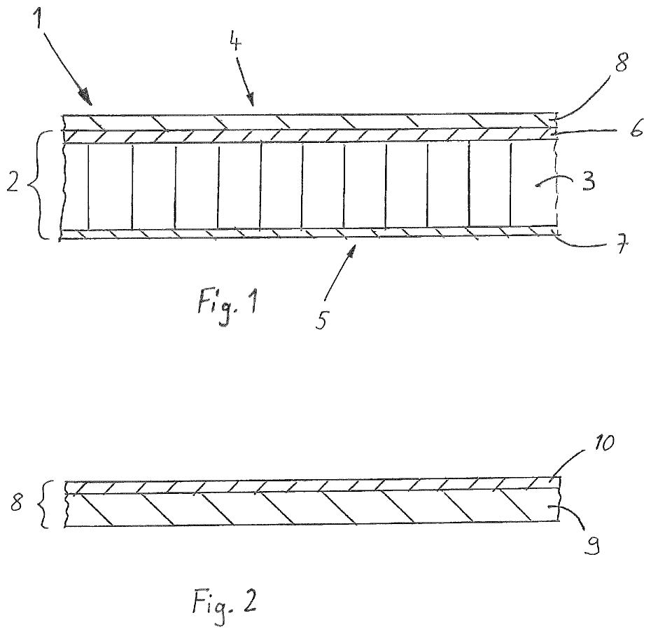

FIG. 2 shows an outer skin layer of the vehicle external surface component from FIG. 1 in a sectional view;

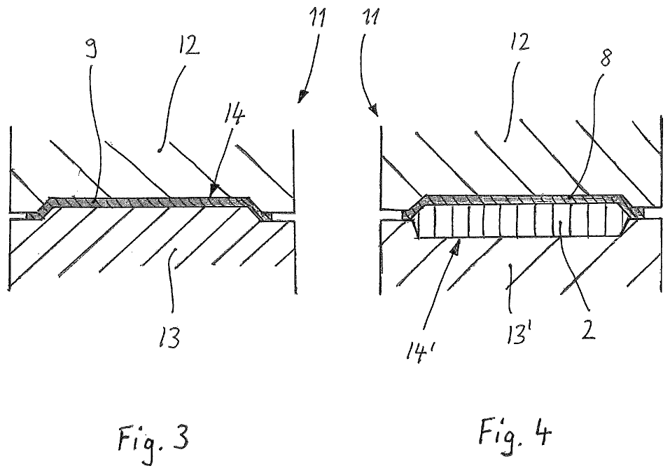

FIG. 3 shows a molding tool with two closed mold halves and an SMC semifinished product of the vehicle external surface component arranged therein during a first production step, in a sectional view; and

FIG. 4 shows the molding tool with a second exchanged mold half and a vehicle external surface component arranged therein during a second production step, in a sectional view.

A vehicle external surface component 1, e.g. a cover of a roof module or an openable roof such as a sliding roof, comprises a reinforcing structure 2 with a core layer 3 which is produced from a honeycomb, e.g. a paper honeycomb, or from a foam. The core layer 3 is provided on each side, i.e. toward the component outer side 4 as well as toward the component inner side 5 of the vehicle external surface component 1, with a cover layer of plastic 6 and 7 respectively. The outer cover layer of plastic 6 as well as the inner cover layer of plastic 7 contain or are formed by a thin adhesive layer consisting in particular of polyurethane, and contain in particular a reinforcing fiber layer or fiber mat consisting e.g. of a fibrous material with basalt fibers, carbon fibers, natural fibers or glass fibers.

An outer skin layer 8 of the vehicle external surface component 1 is connected to the reinforcing structure 2 and/or the core layer 3 by means of the plastic or polyurethane of the outer cover layer of plastic 6. The outer skin layer 8 is formed from an inner layer and an outer layer. The inner layer is a thin, reduced-density and unpaintable SMC layer 9. The outer layer consists of an in-mold coat (IMC) layer 10.

In comparison with known SMC components the SMC layer 9 is formed with a reduced thickness of less than 2 mm. It is preferred that the SMC layer 9 has a thickness of 1.5 mm to 2.0 mm and in particular of 1.5 mm to 1.8 mm. Furthermore, the SMC layer 9 has a reduced density of less than 1.3 kg/dm³ and in particular between 1.2 kg/dm³ and 1.0 kg/dm³.

The reduced density in comparison with known SMC components or SMC semifinished products may be brought about e.g. by the corresponding addition of fillers such as hollow glass beads.

The outer cover layer of plastic 6 as a fiber-containing layer may also be omitted if the SMC layer 9 concomitantly takes on the structural properties of the outer cover layer of plastic 6. The SMC layer 9 is then adhesively bonded directly to the core layer 3 only by means of plastic, such as e.g. polyurethane.

A method for producing such a vehicle external surface component 1 provides that first, an SMC layer 9 including a paintable outer thin IMC layer 10 as a semifinished product is produced in a standard production method for SMC components.

The semifinished product (SMC layer 9 with IMC layer 10) is then inserted into a mold half of a composite mold. If required, the semifinished product is sucked onto the mold half with a vacuum.

In another downstream method step, the reinforcing structure 2 is pressed into the semifinished product with an as yet uncrosslinked adhesive (e.g. polyurethane). In this method step, the surface of the reinforcing structure 2 facing the SMC layer 9 is shaped.

After the demolding of the composite component or vehicle external surface component 1, further method steps are optionally performed, such as e.g. trimming or cutting to size the edges of the vehicle external surface component 1. The vehicle external surface component 1 can then be painted in the color of the car or in a contrasting color.

Another alternative method (see FIGS. 3 and 4) represents the combination of an SMC process with a composite process. A molding tool 11 comprises a first or top mold half 12 and a second or bottom mold half 13. In a mold cavity 14 between the two mold halves 12 and 13, first the SMC layer 9 is pressed and then flooded with an IMC paint layer 10 on the later component outer side by means of the first or top mold half 12 (Class A mold half). As a departure from the first-mentioned method, the semifinished product and/or the outer skin layer 8 (the SMC layer 9 with the IMC paint layer 10) is not removed from the molding tool 11, but rather the counterpunch of the molding tool 11, i.e. the bottom mold half 13, is replaced by an exchanged second mold half 13′ to produce the final composite geometry. This can be performed by exchanging the counterpunch and/or by shuttling or moving the mold halves 13 and/or 13′, the SMC layer 9 remaining on the top mold half 12. The exchanged bottom mold half 13′ comprises an enlarged mold cavity 14′ in which the reinforcing structure 2 is arranged. The composite process then takes place, in which the reinforcing structure 2 is pressed against and connected to the SMC layer 9 of the outer skin layer 8.

As an alternative, the bottom mold half 13 may also be the Class A mold half and both the bottom mold half 13 and the upper mold half 12 may be shuttled. The SMC layer 9 may also optionally remain on the bottom mold half 13′ and the process for applying the reinforcing structure 2 may take place in a second pressing tool.

A great advantage of this method is the omission of additional handling steps for moving the semifinished product, the avoidance of damage to the later surface, and the avoidance of contamination of the composite mold with impurities.

The individual features of the invention disclosed in the description and on the basis of the exemplary embodiments as well as in the figures may be combined with the subject-matter of the invention in its general form in any technically expedient arrangements and configurations.

List of reference signs

| | |
|---|---|
| 1 | Vehicle external surface component |
| 2 | Reinforcing structure |
| 3 | Core layer |
| 4 | Component outer side |
| 5 | Component inner side |
| 6 | Outer cover layer of plastic |
| 7 | Inner cover layer of plastic |
| 8 | Outer skin layer |
| 9 | SMC layer |
| 10 | In-mold coat layer |
| 11 | Molding tool |
| 12 | First mold half |
| 13 | Second mold half |
| 13′ | Exchanged second mold half |
| 14 | Mold cavity |
| 14′ | Enlarged mold cavity |

1. A vehicle external surface component having a layered structure with an SMC layer forming an outer skin layer and having a reinforcing structure connected to the SMC layer and comprising:
a core layer,
wherein the SMC layer has a reduced thickness of less than 2 mm.

2. The vehicle external surface component as claimed in claim 1, wherein the SMC layer is formed by the addition of fillers or hollow glass beads with a reduced density compared to the SMC layer.

3. The vehicle external surface component as claimed in claim 1, wherein the SMC layer has a weight per unit area of less than 4 kg/m².

4. The vehicle external surface component as claimed in claim 1, further comprising a paintable in-mold coat layer applied to the SMC layer and together with the SMC layer forms the outer skin layer.

5. The vehicle external surface component as claimed in claim 1, wherein the reinforcing structure comprises an inner cover layer of plastic that is produced from polyurethane applied to the core layer on its inner side that is opposite the outer skin layer.

6. The vehicle external surface component as claimed in claim 1, further comprising the outer skin layer applied to the outer side of the core layer facing the outer skin layer by an outer cover layer of plastic produced from polyurethane.

7. The vehicle external surface component as claimed in claim 5, wherein the inner cover layer of plastic comprises one of a fiber reinforcement or a fiber mat and wherein the outer cover layer of plastic comprises one of a fiber reinforcement or a fiber mat.

8. The vehicle external surface component as claimed in claim 1, wherein the core layer of the reinforcing structure is produced from one of a honeycomb or a foam, wherein the honeycomb is produced from one of paper, aluminum or a phenolic resin.

9. A method for producing a vehicle external surface component as claimed in claim 1, comprising the steps of:
a) producing an SMC layer including a thin IMC layer as a semifinished product forming an outer skin layer,
b) inserting the coated SMC layer into a mold half of a composite mold,
c) pressing a reinforcing structure bearing the outer skin layer and comprising a core layer covered with at least one cover layer of plastic into the SMC layer with an as yet uncrosslinked adhesive or polyurethane so as to shape the vehicle external surface component, and
d) demolding the vehicle external surface component.

10. The method as claimed in claim 9, wherein, after the step of demolding of the vehicle external surface component comprises the additional step of trimming to size the edges of the vehicle external surface component.

11. The method as claimed in claim 9, wherein in the step of producing an SMC layer
the thin IMC layer is provided with an outer-surface paint finish or
the SMC layer is provided with a paintable thin IMC layer; and further comprises the step of painting the vehicle external surface component.

12. A method for producing a vehicle external surface component as claimed in claim 1, comprising the steps of:
a) producing an SMC layer as a semifinished product in a standard production method for SMC components,
b) inserting the SMC layer into a first mold half of a molding tool and pressing the SMC layer by a second mold half,
c) applying an IMC paint layer to the SMC layer facing the first mold half to form an outer skin layer,
d) exchanging the second mold half for a second mold half with an enlarged mold cavity,
e) inserting a reinforcing structure bearing the outer skin layer and comprising a core layer covered by at least one cover layer of plastic into the enlarged mold cavity, and
f) pressing the reinforcing structure into the SMC layer with an as yet uncrosslinked adhesive or polyurethane to shape the vehicle external surface component.

13. The vehicle external surface component as claimed in claim 1, wherein the SMC layer has a reduced thickness of between 1.5 mm to 2.0 mm.

14. The vehicle external surface component as claimed in claim 1, wherein the SMC layer has a reduced thickness of between 1.5 mm to 1.8 mm.

15. The vehicle external surface component as claimed in claim 1, wherein the SMC layer has a reduced thickness of less than 2 mm and has a reduced density of less than 1.3 kg/dm³.

16. The vehicle external surface component as claimed in claim 1, wherein the SMC layer has a reduced density of less than 1.3 kg/dm³.

17. The vehicle external surface component as claimed in claim 1, wherein the SMC layer has a reduced density of between 1.2 kg/dm³ and 1.0 kg/dm³.

18. The vehicle external surface component as claimed in claim 1, wherein the SMC layer has a reduced thickness of between 1.5 mm to 1.8 mm, and has a reduced density between 1.2 kg/dm³ and 1.0 kg/dm³.

19. The vehicle external surface component as claimed in claim 1, wherein the SMC layer (9) has a weight per unit area of between 2.5 kg/m² and 1.2 kg/m².
